(19) United States
(12) Patent Application Publication
(10) Pub. No.: US 2014/0009683 A1
(43) Pub. Date: Jan. 9, 2014

(54) APPARATUS, METHOD AND PROGRAM FOR IMAGE PROCESSING

(71) Applicant: Sony Corporation, Tokyo (JP)

(72) Inventor: Takuji Yoshida, Chiba (JP)

(73) Assignee: Sony Corporation, Tokyo (JP)

(21) Appl. No.: 13/894,685

(22) Filed: May 15, 2013

(30) Foreign Application Priority Data
Jul. 5, 2012 (JP) 2012-151343

(51) Int. Cl. H04N 9/73

(52) U.S. Cl. CPC H04N 9/73
USPC 348/655

(57) ABSTRACT

There is provided an image processing apparatus including an environment light white balance gain generating section configured to generate an environment light white balance gain from an image taken under environment light, a combined white balance gain generating section configured to combine a fill light white balance gain corresponding to a color temperature of fill light with the environment light white balance gain to generate a combined white balance gain, and a white balance gain correcting section configured to correct the combined white balance gain in accordance with a ratio of the environment light to the fill light. The corrected combined white balance gain is applied to an image taken under mixed light including the fill light and the environment light.

### BACKGROUND

The present technology relates to an apparatus and method for image processing, and a program for making a computer execute the method. More specifically, the present technology relates to an apparatus and method for image processing that includes execution of white balance processing, and a program for making a computer execute the method.

In an imaging apparatus, white balance processing is frequently used to adjust color shades of an image so that accurate color presentation is achieved under a light source at the time of imaging. In the white balance processing, the imaging apparatus determines a proper white balance gain in accordance with a color temperature of environment light that is light in a photographing environment, and adjusts color shades based on the determined white balance gain. The color temperature expresses colors of light beams from various light sources in the form of temperature.

In the case where the imaging apparatus takes an image with use of emission of fill light such as flash light, not only environment light but also the fill light are made incident into the imaging apparatus. Accordingly, if the white balance gain under the environment light is used as it is, it may be difficult to perform proper adjustment. Accordingly, an imaging apparatus has been proposed for taking an image with use of emission of fill light, in which a light amount ratio between the fill light and the environment light is calculated and a proper white balance gain is determined based on the calculated ratio (see, for example, Japanese Patent Laid-Open No. 2010-193002).

### SUMMARY

In the aforementioned related art, with use of the light amount ratio between the environment light and the fill light, the white balance gain in the fill light and the white balance gain in the environment light are combined, and the combined gain is used as a proper gain for an image taken with emission of the fill light. However, in the aforementioned related art, the image taken with emission of the fill light may have unnatural color shades. For example, when the light amount and the color temperature of environment light are extremely lower than those of the fill light, the environment light looks darker than the fill light. Accordingly, the gain combined at the ratio of their light amounts may fail to provide sufficient color shades of the environment light. In contrast, when the color shades of the environment light are insufficient, there may be provided an image of unnatural color shades with the atmosphere of environment light being damaged.

In view of such circumstances, it is desirable, in the present technology, to adjust color shades of an image taken with emission of fill light to be natural color shades.

According to a first embodiment of the present disclosure, there is provided an image processing apparatus, an image processing method and a program to cause a computer to execute the method thereof, the image processing apparatus including an environment light white balance gain generating section configured to generate an environment light white balance gain from an image taken under environment light, a combined white balance gain generating section configured to combine a fill light white balance gain corresponding to a color temperature of fill light with the environment light white balance gain to generate a combined white balance gain, and a white balance gain correcting section configured to correct the combined white balance gain in accordance with a ratio of the environment light to the fill light. The corrected combined white balance gain is applied to an image taken under mixed light including the fill light and the environment light. This brings about a function of performing correction on the white balance gain in accordance with the ratio of the environment light to the fill light.

According to the first embodiment of the present disclosure, the white balance gain correcting section may perform, on the combined white balance gain, correction to change a reference color temperature in accordance with a light amount ratio of the environment light to the fill light. This brings about a function of performing correction to change the reference color temperature in accordance with the light amount ratio of the environment light amount to the fill light.

According to the first embodiment of the present disclosure, the white balance gain correcting section may perform, on the combined white balance gain, correction to generate a color temperature of the environment light from the environment light white balance gain and to change a reference color temperature in accordance with a ratio of the obtained color temperature ratio of the environment light to the color temperature of the fill light. This brings about a function of generating the environment light color temperature from the environment light white balance gain and performing correction to make the reference color temperature higher as the color temperature ratio of the environment light to the fill light is lower.

According to the first embodiment of the present disclosure, the white balance gain correcting section may determine that the ratio of the environment light to the fill light is lower as a depth to an object in the image taken under the environment light is smaller. This brings about a function of determining that the ratio of the environment light to the fill light is lower with a smaller depth.

According to the first embodiment of the present disclosure, the image may have a plurality of regions. The white balance gain correcting section may obtain the ratio of the environment light to the fill light in each of the plurality of regions and may correct the combined white balance in each of the plurality of regions. This brings about a function of correcting the combined white balance in each of a plurality of the regions.

According to the first embodiment of the present disclosure, the image processing apparatus may further include a white balance processing section configured to execute white balance processing of the image taken under the mixed light by using the corrected white balance gain. This brings about a function of performing white balance processing on the image taken under mixed light by using the corrected white balance gain.

The present technology may implement an excellent effect of being able to adjust color shades of an image taken with emission of fill light to be natural color shades.

### BRIEF DESCRIPTION OF THE DRAWINGS

FIG. 1 is a block diagram showing one configuration example of an imaging apparatus in a first embodiment;

FIG. 2 is a block diagram showing one configuration example of an image processing apparatus in the first embodiment;

FIG. 3 is a block diagram showing one configuration example of an environment light white balance gain generating section in the first embodiment;

FIG. 4 is a block diagram showing one configuration example of a combined white balance gain generating section in the first embodiment;

FIG. 5 is a block diagram showing one configuration example of a white balance gain correcting section in the first embodiment;

FIG. 6 is a block diagram showing one configuration example of a white balance processing section in the first embodiment;

FIG. 7 is a view showing one example of live view image data in the first embodiment;

FIG. 8 is a view showing one example of live view image data divided into a plurality of blocks in the first embodiment;

FIG. 9 is a view showing one example of a relation between an environment light contribution ratio and a difference of exposure values in the first embodiment;

FIG. 10 is a view showing one example of a relation between a correction coefficient and an environment light exposure value in the first embodiment;

FIG. 11 is a view showing one example of white balance gains before and after correction in the first embodiment;

FIG. 12 is a flow chart showing one example of operation of the image processing apparatus in the first embodiment;

FIG. 13 is a block diagram showing one configuration example of an image processing apparatus in a second embodiment;

FIG. 14 is a block diagram showing one configuration example of a white balance gain correcting section in the second embodiment;

FIG. 15 is a view showing one example of a relation between a correction coefficient and a color temperature in a modified example of the second embodiment;

FIG. 16 is a block diagram showing one configuration example of an image processing apparatus in a third embodiment;

FIG. 17 is a block diagram showing one configuration example of a white balance gain correcting section in the third embodiment;

FIG. 18 is a view showing one example of a range covered by fill light in third embodiment; and

FIG. 19 is a view showing one example of a relation between a correction coefficient and depth information in a modified example of the third embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, a configuration for carrying out the present technology (hereinafter referred to as an embodiment) will be described. The description will be given in the following order.

1. First embodiment (example of correcting white balance gain in accordance with light amount of environment light)

2. Second embodiment (example of correcting white balance gain in accordance with color temperature of environment light)

3. Third embodiment (example of correcting white balance gain in accordance with the light amount or color temperature of environment light obtained from depth)

### 1. First Embodiment

[Configuration Example of Imaging Apparatus]

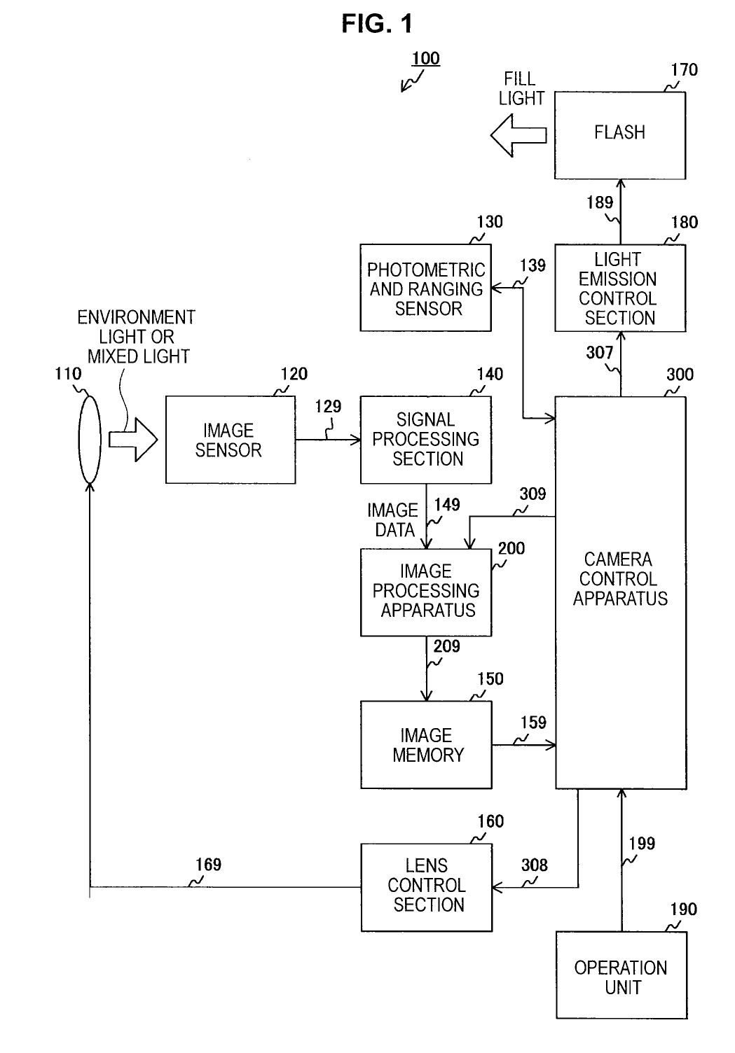

FIG. 1 is a block diagram showing one configuration example of an imaging apparatus 100 in a first embodiment of the present technology. The imaging apparatus 100 includes an imaging lens 110, an image sensor 120, a photometric and ranging sensor 130, a signal processing section 140, an image memory 150, a lens control section 160, a flash 170, a light emission control section 180, and an operation section 190. The imaging apparatus 100 also includes an image processing apparatus 200 and a camera control apparatus 300.

The imaging lens 110 is a lens which forms an image of an imaging target on the image sensor 120. The imaging lens 110 includes lenses such as a focus lens and a zoom lens. When the flash 170 does not emit light, environment light is incident into the imaging lens 110, whereas when the flash 170 emits light, mixed light is incident thereinto. The environment light is the light coming from a light source other than the flash 170, whereas the mixed light is a mixture of fill light, which is the light coming from the flash 170, and the environment light.

The image sensor 120 photoelectrically converts the light from the imaging lens 110 and outputs an electrical signal to the signal processing section 140 via a signal line 129. The image sensor 120 may be implemented by a CCD (Charge Coupled Device) and a CMOS (Complementary Metal Oxide Semiconductor) sensor, or the like.

The photometric and ranging sensor 130 is configured to measure the amount of light which is incident through the image sensor 120 under the control of the camera control apparatus 300. The measured light amount is used to obtain an exposure value or a depth to a subject. The photometric and ranging sensor 130 supplies the measured light amount value to the camera control apparatus 300 via the signal line 139.

The signal processing section 140 is configured to perform CDS (Correlated Double Sampling) processing and AGC (Automatic Gain Control) processing on an electrical signal supplied from the image sensor 120. The CDS processing is for maintaining a sufficient signal noise ratio (S/N ratio), while the AGC processing is for controlling a gain. The signal processing section 140 performs A/D (Analog/Digital) conversion of the thus-obtained signal, forms image data with the obtained digital signal, and outputs the image data to the image processing apparatus 200 via the signal line 149.

The image processing apparatus 200 is configured to perform various kinds of image processing including white balance processing on the image data from the signal processing section 140. The image processing apparatus 200 receives an exposure value from the camera control apparatus 300, and executes white balance processing with use of the exposure value. Details of the white balance processing will be described later. The image processing apparatus 200 outputs image-processed image data to the image memory 150 via the signal line 209. The image memory 150 is configured to store the image data.

The lens control section 160 is configured to control a position of the imaging lens 110 under the control of the camera control apparatus 300. The position of the imaging lens 110 may be controlled, for example, depending on changes in a zooming magnification or a focusing position.

The flash 170 is configured to emit light under the control of the light emission control section 180 to generate fill light. The amount of fill light is configured to be a fixed value. The light emission control section 180 controls emission operation of the flash 170 under the control of the camera control apparatus 300.

The operation section 190 is configured to generate a manipulate signal in accordance with an operation of a user with respect to a touch panel, a shutter release button, or the like, and to output the signal to the camera control apparatus 300 via the signal line 199.

The camera control apparatus 300 is configured to control the entire imaging apparatus 100. The camera control apparatus 300 controls the photometric and ranging sensor 130 to measure light at the time when the flash 170 emits light and at the time when the flash 170 does not emit light, respectively. The camera control apparatus 300 then determines a proper exposure value in accordance with the light amount measured by the photometric and ranging sensor 130. When there are a plurality of photometry areas, an exposure value is determined from a statistical amount (e.g., an average value) of those photometric quantities. The camera control apparatus 300 determines a shutter speed and a diaphragm amount from the exposure value. The camera control apparatus 300 supplies exposure values, each corresponding to respective light amounts at the time when the flash 170 emits light and at the time when the flash 170 does not emit light, to the image processing apparatus 200 via the signal line 309.

The camera control apparatus 300 also obtains a depth to a subject based on the light amount measured by the photometric and ranging sensor 130 at the time when the flash 170 does not emit light. The camera control apparatus 300 determines a focusing position of the imaging lens 110 based on the depth, and makes the lens control section 160 change the position of the imaging lens 110.

Further, the camera control apparatus 300 determines, based on a manipulate signal from the operation section 190, whether or not the shutter release button is pressed. In the case where it is desirable that the flash 170 emits light, more specifically, in such a case where the shutter release button is pressed, the camera control apparatus 300 controls the light emission control section 180 to make the flash 170 emit light. The camera control apparatus 300 then reads image data, which was taken at the time when the flash 170 emitted light or when the flash 170 did not emit light, from the image memory 150, and outputs the image data to a display device, a recording device, and the like.

Although the imaging apparatus 100 performs white balance processing on the A/D-converted image data, an analog electrical signal prior to A/D conversion may be subjected to white balance processing in the signal processing section 140.

Although the image processing apparatus 200 is configured to be provided in the imaging apparatus 100, the present technology is not limited to this configuration. The image processing apparatus 200 may be provided in an information processing apparatus such as a personal computer.

[Configuration Example of Image Processing Apparatus]

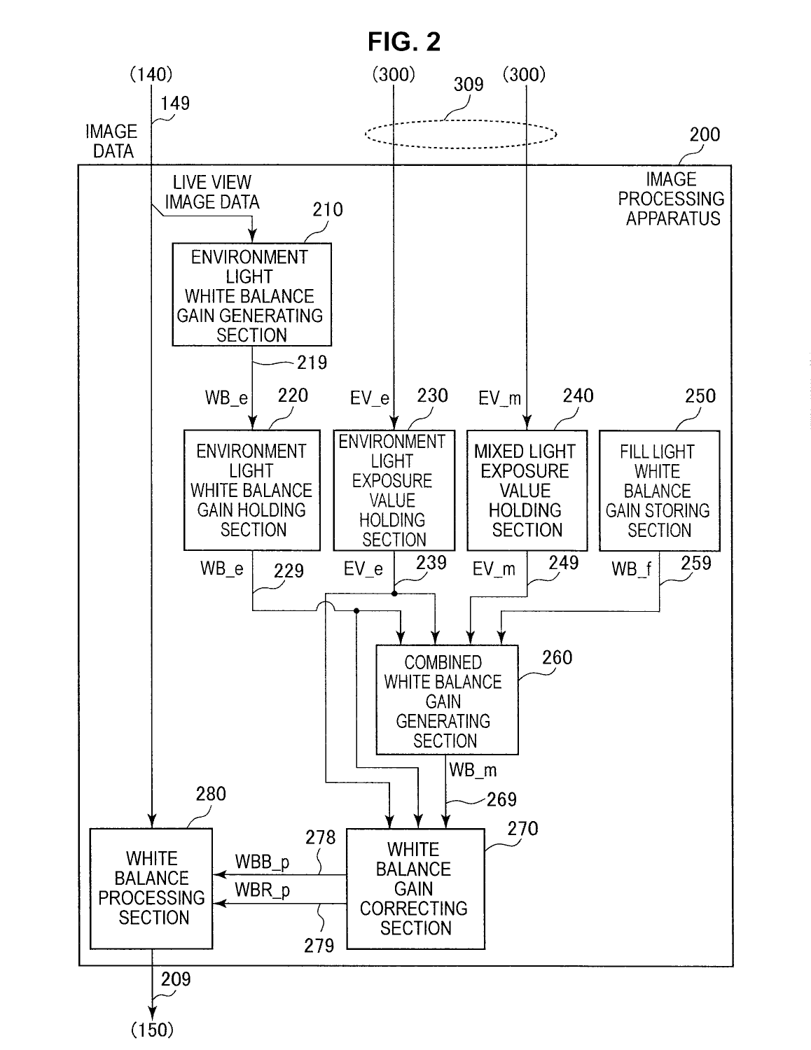

FIG. 2 is a block diagram showing a configuration example of a first image processing apparatus 200. The image processing apparatus 200 includes an environment light white balance gain generating section 210, an environment light white balance gain holding section 220, an environment light exposure value holding section 230, a mixed light exposure value holding section 240, and a fill light white balance gain storing section 250. The image processing apparatus 200 also includes a combined white balance gain generating section 260, a white balance gain correcting section 270, and a white balance processing section 280.

The environment light white balance gain generating section 210 is configured to generate, as an environment light white balance gain WB_e, a white balance gain with the color temperature of environment light as a reference color temperature. The environment light white balance gain generating section 210 acquires, out of image data from the signal processing section 140, image data taken under the environment light. For example, the environment light white balance gain generating section 210 acquires live view image data that is image data taken in a live view mode. The environment light white balance gain generating section 210 then calculates a statistical amount (e.g., a sum or an average value) of brightness values in every color in this live view image data, and calculates the environment light white balance gain WB_e from those statistical amounts. However, if a brightness value of a subject with high saturation is used as a statistic target in calculation of the statistical amounts, a color failure phenomenon that involves biased color may possibly occur. Accordingly, the environment light white balance gain generating section 210 may exclude from statistic targets the brightness values of subjects with a rather high saturation.

For example, in an image made up of three colors including R (Red), G (Green), and B (Blue), the environment light white balance gain generating section 210 calculates sums of brightness values for respective colors as Rsum, Gsum, and Bsum. The environment light white balance gain generating section 210 calculates R gain, G gain, and B gain by using any one of the sums (for example, Gsum) as a reference value, which are gains of respective colors, so that values amplified with the gains may be equal to the reference value. More specifically, the environment light white balance gain generating section 210 obtains an R gain WBR_e and a B gain WBR_e in the environment light white balance gain by using the following formula 1 and formula 2. The value of G gain is set at “1”. A statistical amount of G component is used as a reference because green color tends to occupy larger area in an image compared to other colors.

WBR_{—}e=Gsum/Rsum Formula 1

WBB_{—}e=Gsum/Bsum Formula 2

The environment light white balance gain generating section 210 holds the environment light white balance gain WB_e, which includes the obtained R gain WBR_e and B gain WBR_e, in the environment light white balance gain holding section 220.

The environment light white balance gain holding section 220 is configured to hold the environment light white balance gain WB_e generated by the environment light white balance gain generating section 210.

The environment light exposure value holding section 230 is configured to hold an environment light exposure value EV_e supplied from the camera control apparatus 300. In this case, the environment light exposure value EV_e is an exposure value corresponding to the light amount measured at the time when the flash 170 does not emit light, i.e., the light amount of environment light.

The mixed light exposure value holding section 240 is configured to hold the mixed light exposure value EV_m supplied from the camera control apparatus 300. In this case, the mixed light exposure value EV_m is an exposure value corresponding to the light amount measured at the time when the flash 170 emits light, i.e., the light amount of mixed light.

These environment light exposure value EV_e and mixed light exposure value EV_m are values corresponding to the light amounts of environment light and mixed light, respectively. Since the exposure value increases by “1” whenever the light amount decreases by half, a light amount ratio between environment light and fill light in the mixed light may be calculated from the environment light exposure value EV_e and the mixed light exposure value EV_m.

The fill light white balance gain storing section 250 is configured to store a fill light white balance gain WB_f having a preset fill light color temperature as the reference color temperature. For example, a white balance gain having a reference color temperature of 6000K is set as a fill light white balance gain WB_f.

The combined white balance gain generating section 260 is configured to combine the environment light white balance gain WB_e and the fill light white balance gain WB_f at the light amount ratio between environment light and fill light. More specifically, the combined white balance gain generating section 260 reads the environment light exposure value EV_e and the mixed light exposure value EV_m from the environment light exposure value holding section 230 and the mixed light exposure value holding section 240. The combined white balance gain generating section 260 also reads the environment light white balance gain WB_e and the fill light white balance gain WB_f from the environment light white balance gain holding section 220 and the fill light white balance gain storing section 250.

The combined white balance gain generating section 260 then obtains the light amount ratio between environment light and fill light based on the environment light exposure value EV_e and the mixed light exposure value EV_m. The combined white balance gain generating section 260 combines the environment light white balance gain WB_e and the fill light white balance gain WB_f at the obtained light amount ratio. The combined white balance gain generating section 260 supplies the combined white balance gain to the white balance gain correcting section 270 via a signal line 269 as a combined white balance gain WB_m.

The white balance gain correcting section 270 is configured to correct the combined white balance gain WB_m in accordance with the light amount ratio of the environment light to the fill light. For example, the white balance gain correcting section 270 performs, on the combined white balance gain WB_m, correction to make the reference color temperature higher as the light amount ratio of the environment light to the fill light is lower. The white balance gain correcting section 270 reads out the environment light white balance gain WB_e from the environment light white balance gain holding section 220, and reads out the environment light exposure value EV_e from the environment light exposure value holding section 230. Since the light amount of fill light is fixed as described before, the white balance gain correcting section 270 can calculate a relative light amount of the environment light to the fill light only from the environment light exposure value EV_e.

The white balance gain correcting section 270 performs, on the combined white balance gain WB_m, correction to make the reference color temperature higher as the relative light amount of the environment light to the fill light is lower. However, when the relative light amount of environment light is equal to or more than a threshold, the environment light is sufficiently bright and therefore correction may not be necessary. Accordingly, when the amount of environment light is equal to or more than the threshold, the white balance gain correcting section 270 sets the correction amount to be fixed regardless of the amount of the environment light.

In correcting operation, the white balance gain correcting section 270 increases the reference color temperature by correcting at least one of R gain and B gain so that a ratio of R gain to B gain may increase. Generally, the environment light low in light amount has a color temperature lower than that of fill light, and its color shades are close to red as compared with the color shades of the fill light.

Accordingly, the color shades of the environment light that are close to red are emphasized by increasing the ratio of R gain to B gain. The white balance gain correcting section 270 supplies the corrected gain to the white balance processing section 280 via signal lines 278 and 279 as a proper white balance gain WB_p which is to be applied to image data taken under mixed light. The proper white balance gain WB_p includes B gain WBB_p and R gain WBR_p.

When the relative light amount of environment light is low, the color shades of environment light in an image may be insufficient due to insufficient brightness of the environment light. However, the correction to make the reference color temperature higher emphasizes the color shades of the environment light, so that the image may obtain natural color shades.

Note that the white balance gain correcting section 270 performs correction on the assumption that environment light is lower in a color temperature than fill light. On the contrary, however, the environment light color temperature may be higher than the fill light color temperature in some cases. For example, when blue illumination light is environment light, the environment light is lower in a color temperature than the fill light. Whether or not the environment light color temperature is higher than the fill light color temperature is determined by the white balance gain correcting section 270 based on the color temperature corresponding to the environment light white balance gain WB_e. If it is determined that the environment light color temperature is higher than the fill light color temperature, the white balance gain correcting section 270 performs, on the combined white balance gain WB_m, correction to make the reference color temperature lower as the light amount ratio of environment light to fill light is lower. As a consequence, the color shades of environment light are emphasized, so that the image obtains natural color shades.

The white balance processing section 280 is configured to perform, on the image data taken under mixed light, white balance processing which uses a proper white balance gain WB_p. The white balance processing section 280 holds the white balance-processed image data in the image memory 150.

Although the image processing apparatus 200 targets RGB color model image data for processing, image data other than the RGB color model, such as CMYK (Cyan, Magenta, Yellow, Black) color model image data, may be targeted for processing.

Although the image processing apparatus 200 obtains the light amount ratio between environment light and fill light based on the exposure value, the light amount ratio may be calculated based on other parameters. For example, the image processing apparatus 200 may obtain the light amount ratio based on illuminance or brightness.

The image processing apparatus 200 may further execute image processing, such as gamma correction processing and demosaicing, besides the white balance processing. In that case, the white balance processing may be performed prior to other processings such as demosaicing, or may be performed after other processings.

[Configuration Example of Environment Light White Balance Gain Generating Section]

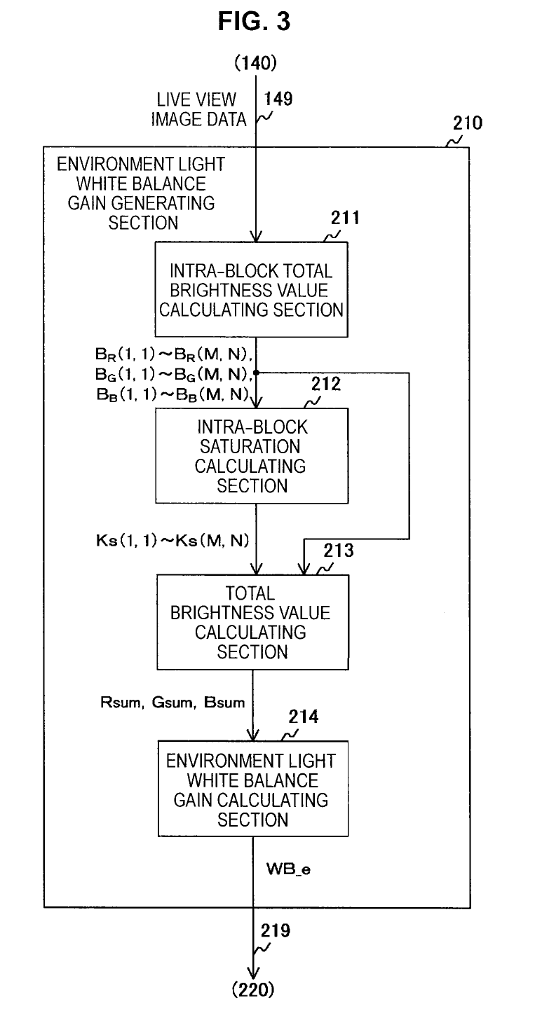

FIG. 3 is a block diagram showing one configuration example of the environment light white balance gain generating section 210 in the first embodiment. The environment light white balance gain generating section 210 includes an intra-block total brightness value calculating section 211, an intra-block saturation calculating section 212, a total brightness value calculating section 213, and an environment light white balance gain calculating section 214.

The intra-block total brightness value calculating section 211 is configured to calculate a sum of brightness values of respective colors in every block in live view image data. The term block is a name indicating each region obtained by dividing the live view image data into a plurality of regions. For example, in the case of image data having r pixels arranged in a row direction and c pixels arranged in a column direction so as to form a two-dimensional lattice configuration, r pixels in the row direction are divided into M blocks, and c pixels in the column direction are divided into N blocks. Herein, variables r and c are integers of 2 or larger. A variable M is an integer less than r and equal to or more than 1, while a variable N is an integer less than c and equal to or more than 1. The intra-block total brightness value calculating section 211 calculates a sum of brightness values of every R, G, and B colors in each block, and supplies them as B_{R}(i, j), B_{G}(i, j), and B_{B}(i, j) to the intra-block saturation calculating section 212 and the total brightness value calculating section 213. Herein, a variable i is an integer of 1 through M, and a variable j is an integer of 1 through N.

The intra-block saturation calculating section 212 is configured to calculate saturation in every block. The intra-block saturation calculating section 212 calculates saturation Sb(i, j) of each block based on B_{R}(i, j), B_{G}(i, j), and B_{B}(i, j) by using, for example, the following formulas 3 through 5.

Mb(i,j)=max{B_{R}(i,j),B_{G}(i,j),B_{B}(i,j)} Formula 3

mb(i,j)=min{B_{R}(i,j),B_{G}(i,j),B_{B}(i,j)} Formula 4

Sb(i,j)={Mb(i,j)−mb(i,j)}/Mb(i,j) Formula 5

In the formula 3, “max( )” is a function which returns a maximum value among values in parentheses. In the formula 4, “min( )” is a function which returns a minimum value among values in parentheses. In the formula 5, if both values of Mb(i, j) and mb(i, j) take “0”, a right-hand side becomes indefinite. Accordingly, exception handling is employed to set “0” in Sb(i, j).

The intra-block saturation calculating section 212 generates, as a saturation coefficient Ks(i, j), a coefficient which takes a larger value as the saturation Sb(i, j) takes a smaller value. For example, the intra-block saturation calculating section 212 generates, as a saturation coefficient Ks(i, j), a coefficient which takes a value of “1” when the saturation Sb(i, j) is smaller than a specified threshold and a value of “0” when the saturation Sb(i, j) is equal to or larger than the threshold. The intra-block saturation calculating section 212 supplies the generated saturation coefficient Ks(i, j) to the total brightness value calculating section 213.

The total brightness value calculating section 213 is configured to calculate a total brightness value of every color in image data based on the total brightness value and the saturation coefficient in each block. The total brightness value calculating section 213 calculates the total brightness value based on the total brightness values B_{R}(i, j), B_{G}(i, j) and B_{B}(i, j), and the saturation coefficient Ks(i, j) in each block by using, for example, the following formulas 6 through 8. The total brightness value calculating section 213 supplies the calculated total brightness value to the environment light white balance gain calculating section 214.

$$\begin{matrix}Rsum = {\sum }_{i = 1}^{M} {\sum }_{j = 1}^{N} {B}_{R} ( i , j ) Ks ( i , j ) & Formula 6 \\ Gsum = {{\sum }_{i = 1}}^{M} {\sum }_{j = 1}^{N} {B}_{G} ( i , j ) Ks ( i , j ) & Formula 7 \\ Bsum = {\sum }_{i = 1}^{M} {\sum }_{j = 1}^{N} {B}_{B} ( i , j ) Ks ( i , j ) & Formula 8\end{matrix}$$

The environment light white balance gain calculating section 214 is configured to calculate an environment light white balance gain WB_e from the total brightness value of each color. The environment light white balance gain calculating section 214 calculates the environment light white balance gain WB_e based on the total brightness values Rsum, Gsum, and Bsum by using the formulas 1 and 2, and holds the calculated value in the environment light white balance gain holding section 220.

[Configuration Example of Combined White Balance Gain Calculating Section]

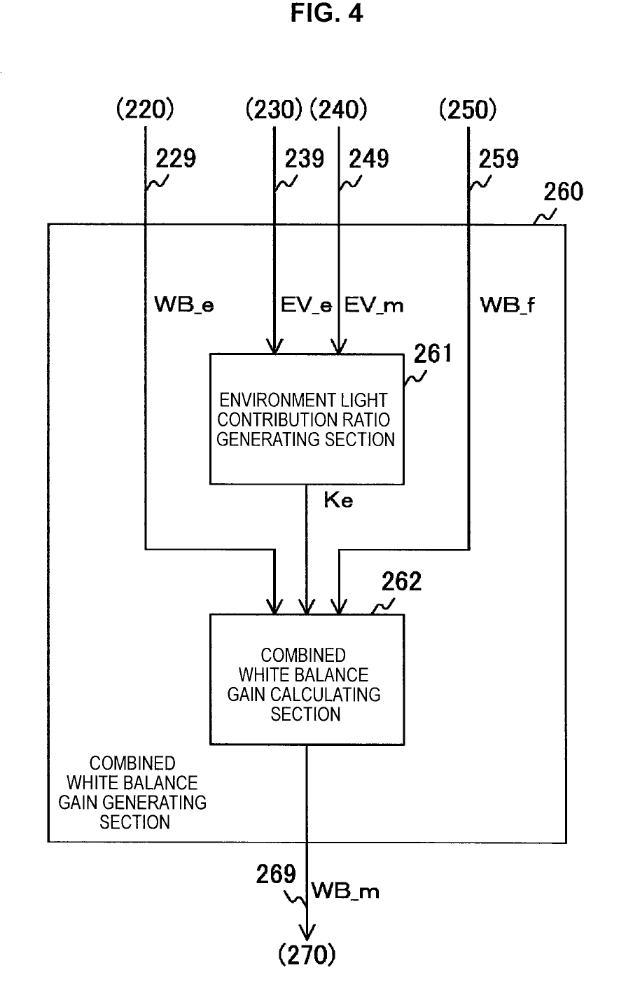

FIG. 4 is a block diagram showing one configuration example of the combined white balance gain generating section 260 in the first embodiment. The combined white balance gain generating section 260 includes an environment light contribution ratio generating section 261 and a combined white balance gain calculating section 262.

The environment light contribution ratio generating section 261 is configured to calculate, as an environment light contribution ratio Ke, a light amount ratio of environment light to mixed light based on the environment light exposure value EV_e and the mixed light exposure value EV_m. The environment light contribution ratio generating section 261 calculates the environment light contribution ratio Ke with, for example, the following formula 9. The environment light contribution ratio generating section 261 supplies the calculated environment light contribution ratio Ke to the combined white balance gain calculating section 262. It is to be noted that the environment light contribution ratio generating section 261 may associate a difference of exposure values with an environment light contribution ratio Ke calculated with use of the formula 9 and the like, store them in a table, and may read out the environment light contribution ratio Ke associated with the difference from the table.

Ke=1/{2̂(EV_{—}e−EV_{—}m)} Formula 9

The combined white balance gain calculating section 262 is configured to calculate the combined white balance gain WB_m. The combined white balance gain calculating section 262 calculates the combined white balance gain WB_m based on the environment light white balance gain WB_e, the fill light white balance gain WB_f, and the environment light contribution ratio Ke by using, for example, the following formulas 10 and 11. The combined white balance gain calculating section 262 supplies the calculated combined white balance gain WB_m to the white balance gain correcting section 270.

WBR_{—}m=Ke×WBR_{—}e+(1−Ke)×WBR_{—}f Formula 10

WBB_{—}m=Ke×WBB_{—}e+(1−Ke)×WBB_{—}f Formula 11

In the formula 10, a variable WBR_m is R gain in the combined white balance gain WB_m. In the formula 11, a variable WBB_m is B gain in the combined white balance gain WB_m.

For example, when the light amount ratio of the environment light to the fill light is 1:2, the environment light contribution ratio Ke is equal to 1/3. In this case, the environment light white balance gain WB_e and the fill light white balance gain WB_f are combined at the ratio of 1:2 according to the formulas 10 and 11.

[Configuration Example of White Balance Gain Correcting Section]

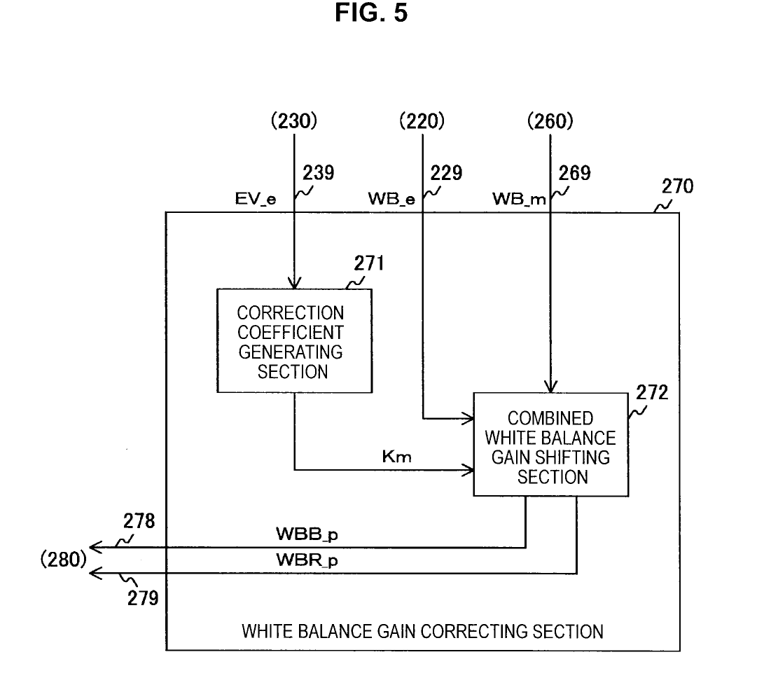

FIG. 5 is a block diagram showing one configuration example of the white balance gain correcting section 270 in the first embodiment. The white balance gain correcting section 270 includes a correction coefficient generating section 271 and a combined white balance gain shifting section 272.

The correction coefficient generating section 271 is configured to generate a larger correction coefficient Km as the relative light amount of environment light to fill light is smaller. The correction coefficient Km is a coefficient used for calculating a correction amount for the correction to increase the reference color temperature of the combined white balance gain WB_m. As the correction coefficient Km is larger, an increase amount of the reference color temperature becomes larger. The correction coefficient generating section 271 reads the environment light exposure value EV_e from, for example, the environment light exposure value holding section 230. If the environment light exposure value EV_e is larger than a threshold EVₜₕ, the correction coefficient generating section 271 calculates a correction coefficient Km by using, for example, the following formula 12. If the environment light exposure value EV_e is equal to or lower than the threshold EVₜₕ, the correction coefficient Km is set to be a fixed value. The fixed value is a value acquired by, for example, substituting EV_th in the formula 12.

Km=a×EV_{—}e+b Formula 12

In the formula 12, a variable a is a positive real number and a variable b is a specified real number.

It is to be noted that the correction coefficient generating section 271 may calculate the correction coefficient Km with a formula other than the formula 12 as long as a coefficient that is changed by depending on the relative light amount of environment light can be calculated. For example, the correction coefficient generating section 271 may calculate the correction coefficient by a quadratic formula, a logarithmic function formula, or the like. In addition, although the correction coefficient generating section 271 calculates the correction coefficient Km by the calculation formulas, the present technology is not limited to this configuration. For example, the correction coefficient generating section 271 may be configured to store a table which associates an environment light exposure value EV_e with a correction coefficient Km calculated based on the value EV_e by using the formula 12 and the like, and to read out the correction coefficient Km from the table.

The combined white balance gain shifting section 272 is configured to perform, on the combined white balance gain WB_m, correction to shift its gain to a higher gain as the light amount ratio of environment light to fill light is lower. The combined white balance gain shifting section 272 calculates a proper combined white balance gain WB_p based on the combined white balance gain WB_m, the environment light white balance gain WB_e, and the correction coefficient Km by using, for example, the following formulas 13 and 14.

WBR_{—}p=WBR_{—}m+Km×(WBR_{—}m−WBR_{—}e) formula 13

WBB_{—}p=WBB_{—}m+Km×(WBB_{—}m−WBB_{—}e) formula 14

In the formula 13, a variable WBR_p is R gain in the proper white balance gain WB_p. In the formula 14, a variable WBR_p is B gain in the proper white balance gain WB_p. The combined white balance gain shifting section 272 supplies the calculated proper white balance gain WB_p to the white balance processing section 280.

Although the white balance gain correcting section 270 generates the proper white balance gain WB_p to be applied to the entire image, a proper white balance gain WB_p to be applied to a block may be generated for every block in the image data. For example, the correction coefficient generating section 271 acquires an environment light exposure value EV_e (i, j) for every block (i, j) in the image data. The correction coefficient generating section 271 then generates a correction coefficient Km(i, j) for every block based on those environment light exposure values EV_e (i, j). The combined white balance gain shifting section 272 generates a proper white balance gain WB_p (i, j) for every block based on those correction coefficients Km(i, j).

[Configuration Example of White Balance Processing Section]

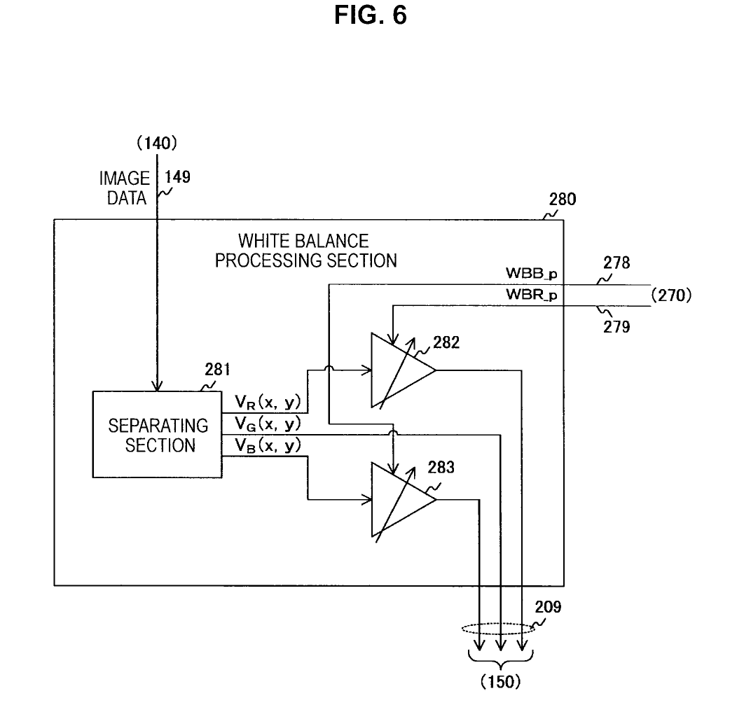

FIG. 6 is a block diagram showing one configuration example of the white balance processing section 280 in the first embodiment. The white balance processing section 280 includes a separating section 281 and gain variable amplifiers 282 and 283.

The separating section 281 is configured to separate brightness values of respective colors in pixels of image data. The separating section 281 supplies a brightness value V_{R}(x, y) of a color R in a pixel (x, y) to the gain variable amplifier 282, while supplying a brightness value V_{B}(x, y) of a color B in the pixel (x, y) to the gain variable amplifier 283. The separating section 281 outputs the brightness value VG(x, y) of the color G in a pixel (x, y) to the image memory 150 without passing through the gain variable amplifier 282 or 283. Herein, a variable x is an integer of 1 through r, and a variable y is an integer of 1 through c.

The gain variable amplifiers 282 and 283 are configured to amplify the brightness values of the colors R and B with the proper white balance gain WB_p. The gain variable amplifier 282 amplifies the brightness value V_{R}(x, y) with R gain WBR_p in the proper white balance gain WB_p, and outputs the amplified value to the image memory 150. The gain variable amplifier 283 amplifies the brightness value V_{B}(x, y) with a B gain WBB_p in the proper white balance gain WB_p, and outputs the amplified value to the image memory 150.

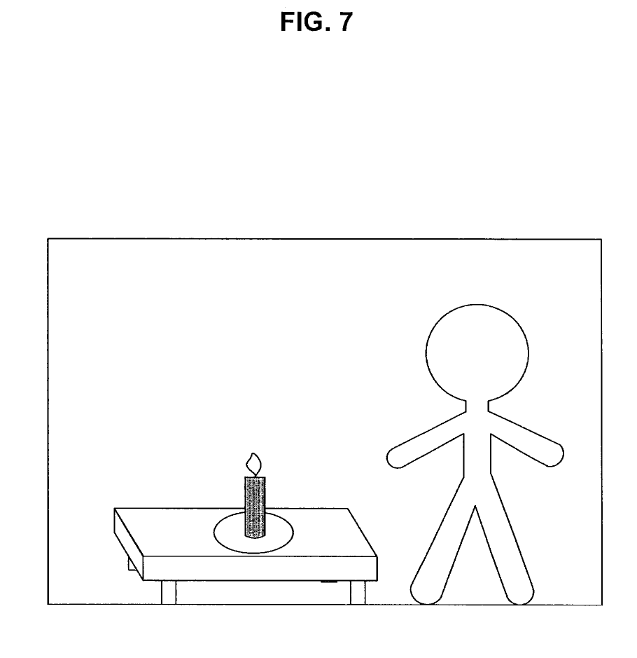

FIG. 7 is a view showing one example of live view image data divided into a plurality of blocks in the first embodiment. The live view image data shows a candle as a light source other than the flash 170. The amount of environment light from the candle is often much smaller than the light amount of fill light. In this case, the white balance gain WB_m determined in accordance with the light amount ratio may result in the environment light with insufficient color shades due to insufficient brightness.

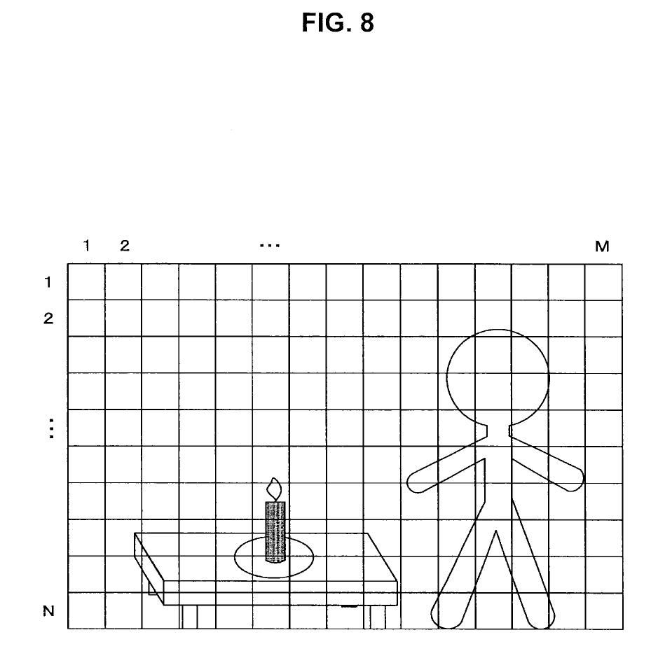

FIG. 8 is a view showing one example of live view image data divided into a plurality of blocks in the first embodiment. As shown in FIG. 8, the live view image data is divided into M×N blocks. A statistical amount of the brightness values and saturation are calculated in each block, and the environment light white balance gain WB_e is obtained therefrom.

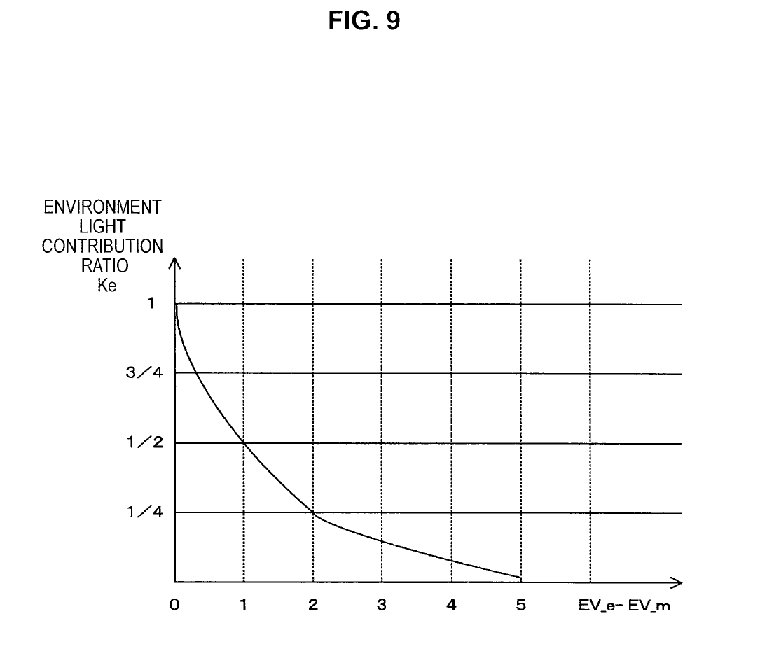

FIG. 9 is a view showing one example of a relation between an environment light contribution ratio and a difference of exposure values in the first embodiment. In FIG. 9, a vertical axis represents an environment light contribution ratio Ke, while a horizontal axis represents a difference between the environment light exposure value EV_e and the mixed light exposure value EV_m, i.e., EV_e−EV_m.

The environment light contribution ratio Ks becomes smaller as a difference between the environment light exposure value EV_e and the mixed light exposure value EV_m is made larger. For example, if the environment light exposure value EV_e is larger than the mixed light exposure value EV_m by “1”, the amount of environment light is half the amount of the mixed light. Therefore, the environment light contribution ratio Ks that is a ratio of the environment light to mixed light becomes “1/2”. If the environment light exposure value EV_e is larger than the mixed light exposure value EV_m by “2”, the amount of environment light becomes “1/4” of the amount of mixed light, so that the environment light contribution ratio Ks becomes “1/4”. Thus, every time the difference of the exposure values increases by “1”, the environment light contribution ratio Ks decreases by half. It is to be noted that the environment light contribution ratio Ks does not exceed “1” since the amount of environment light does not surpass the amount of mixed light that includes the environment light.

At the light amount ratio obtained from the exposure values, the environment light white balance gain WB_e and the fill light white balance gain WB_f are combined.

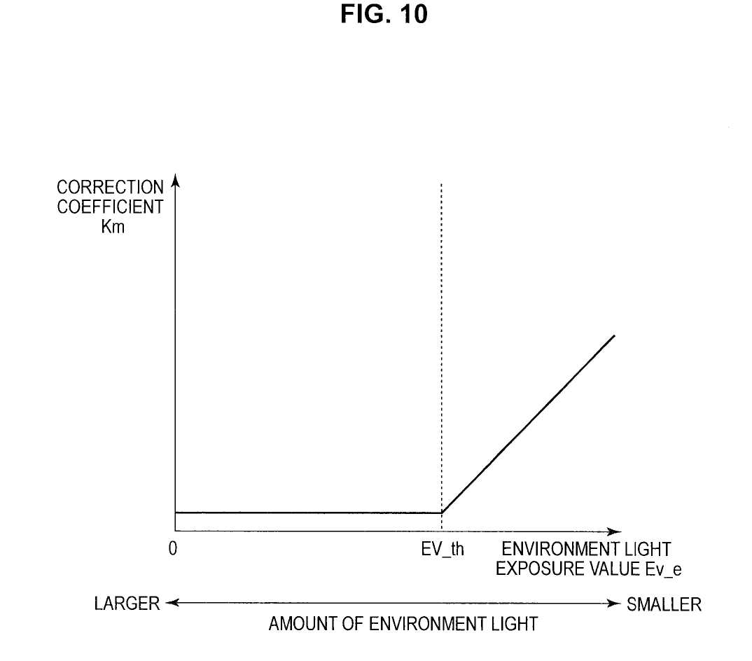

FIG. 10 is a view showing one example of a relation between the correction coefficient Km and the environment light exposure value EV_e in the first embodiment. In FIG. 10, a vertical axis represents the correction coefficient Km while a horizontal axis represents the environment light exposure value EV_e. As illustrated in FIG. 10, as the amount of environment light becomes smaller, i.e., as the threshold EV_e becomes larger, a larger value is set as the correction coefficient Km. The correction to make the reference color temperature higher with the correction coefficient Km being larger is performed on the combined white balance gain WB_m. However, if the environment light exposure value EV_e is equal to or below the threshold EV_th, the environment light is sufficiently bright and therefore the need for correction is lowered, so that a fixed value is set as the correction coefficient Km. This makes it possible to suppress excessive correction.

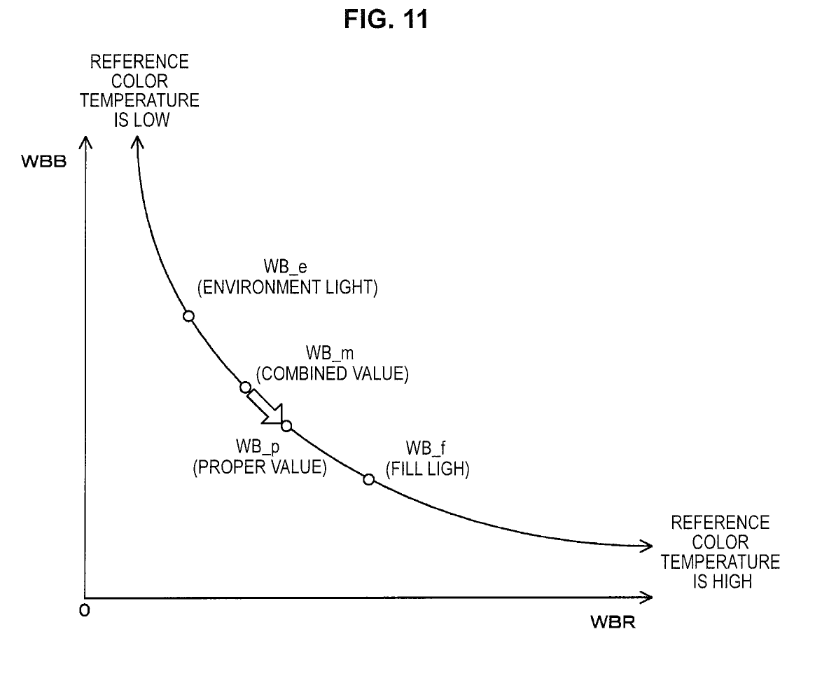

FIG. 11 is a view showing one example of white balance gains before and after correction in the first embodiment. In FIG. 11, a vertical axis represents B gain WBB among white balance gains, while a horizontal axis represents R gain WBR. A curve represents a locus of a combination of R gain corresponding to the reference color temperature and B gain. The higher the reference color temperature of the white balance gain becomes, the larger the ratio of R gain to B gain is made.

Assumed is a case where the amount of environment light is smaller than that of fill light. The environment light with a relatively small light amount is generally lower in a color temperature than the fill light. In other words, the environment light has a color closer to red color than fill light. Accordingly, in order to adjust so that the color, which is closer to red color, is whitened, the environment light white balance gain WB_e in which the ratio of R gain to B gain is small is set. On the contrary, in the case of the fill light which has color shades closer to blue color, the fill light white balance gain WB_f in which the ratio of R gain to B gain is large is set.

The image processing apparatus 200 combines the fill light white balance gain WB_f and the environment light white balance gain WB_e at the light amount ratio of the fill light and the environment light in the mixed light. The combined value WB_m is a value between the fill light white balance gain WB_f and the environment light white balance gain WB_e.

In the case where the color temperature of the environment light is lower than that of the fill light, the combined white balance gain WB_m becomes closer to the value of the environment light white balance gain WB_e, and the ratio of R gain to B gain becomes smaller as the relative light amount of the environment light is made smaller. As a result, color shades close to red color may become insufficient in the environment light. Accordingly, the image processing apparatus 200 performs correction to make the reference color temperature higher as the light amount ratio of the environment light to fill light is smaller. In other words, the image processing apparatus 200 performs correction to shift the combined white balance gain WB_m to a value WB_p having a larger ratio of R gain to B gain. As a consequence, the color shades close to red color are emphasized in the environment light, so that an image of natural color shades which reproduces the atmosphere of environment light is obtained. On the contrary, in the case where the color temperature of the environment light is higher than that of the fill light, the image processing apparatus 200 performs correction to make the reference color temperature lower as the light amount ratio of the environment light to the fill light is smaller. As a consequence, color shades close to blue color are emphasized in the environment light, so that an image of natural color shades which reproduces the atmosphere of environment light is obtained.

[Operational Example of Image Processing Apparatus]

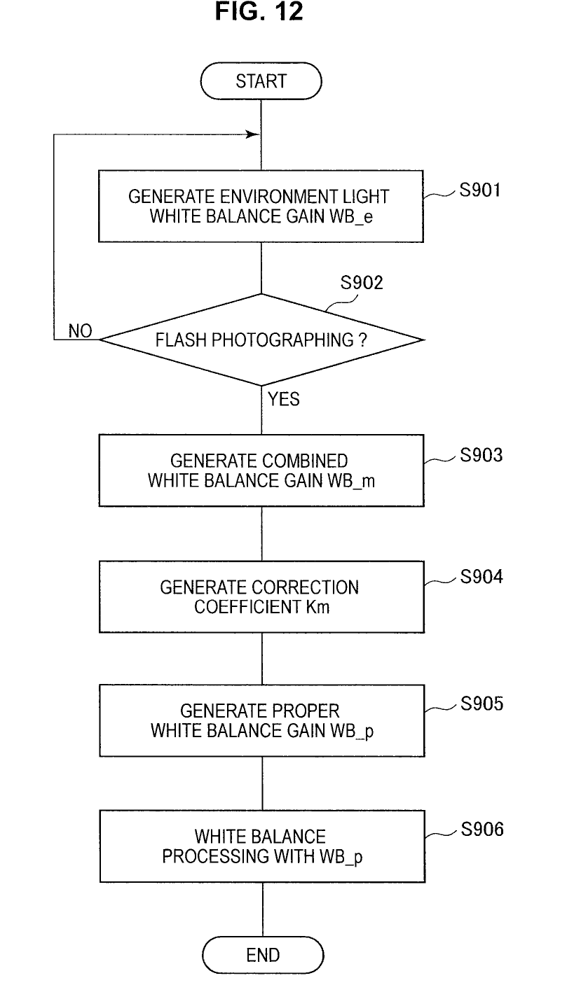

FIG. 12 is a view showing one example of operation of the image processing apparatus 200 in the first embodiment. The operation is started, for example, when live view image data is inputted into the image processing apparatus 200.

The image processing apparatus 200 generates an environment light white balance gain WB_e based on the live view image data by using the formulas 1 through 8 (Step S901). The image processing apparatus 200 determines whether or nor flash photographing is performed (Step S902). When flash photographing is not performed, (Step S902: No), the image processing apparatus 200 return to Step S901.

When flash photographing is performed, (Step S902: Yes), the image processing apparatus 200 generates a combined white balance gain WB_m by using formulas 9 through 11 (Step S903). The image processing apparatus 200 then generates a correction coefficient Km by using the formula 12 (Step S904).

The image processing apparatus 200 generates a proper white balance WB_p by using the formulas 13 and 14 (Step S905). The image processing apparatus 200 then executes white balance processing with respect to the image data taken by flash photographing with use of the proper white balance WB_p (Step S906). After Step S906, the image processing apparatus 200 ends the operation.

Thus, according to the first embodiment of the present technology, the image processing apparatus 200 can correct the combined white balance gain WB_m in accordance with the ratio of environment light to fill light. As a consequence, color shades of the environment light are emphasized in accordance with the ratio. Therefore, the image processing apparatus 200 can adjust the color shades of the image data to be natural color shades.

### 2. Second Embodiment

[Configuration Example of Image Processing Apparatus]

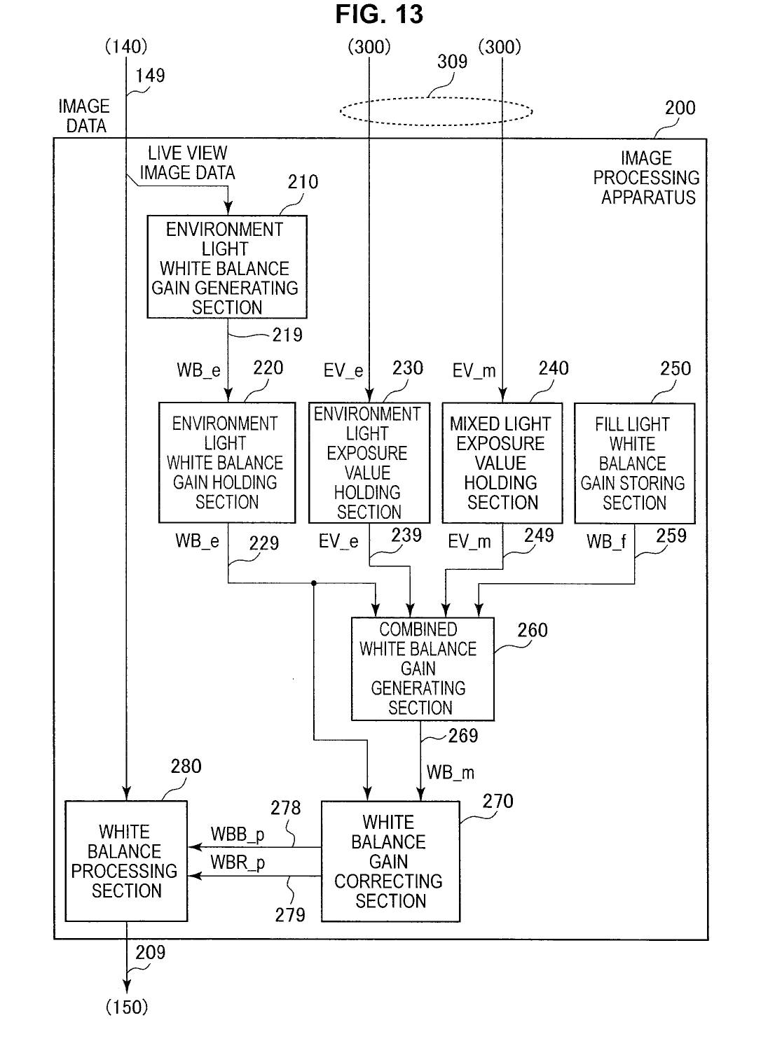

FIG. 13 is a block diagram showing one configuration example of an image processing apparatus 200 in a second embodiment. In the first embodiment, the image processing apparatus 200 performs correction to change the reference color temperature in accordance with the light amount ratio of environment light to fill light under a premise that the color temperature of the environment light is changed in accordance with the light amount ratio. However, the color temperature of the environment light may not change in accordance with the light amount ratio of the environment light to the fill light in some cases. For example, when the environment light is light from an artificial light source such as a fluorescent light, the color temperature of the environment light is sometimes not very low as compared to that of the fill light even when the light amount ratio of the environment light to the fill light is small. If correction to increase the reference color temperature is performed in such a case, the color temperature may possibly become too high. In order to prevent such excessive correction, it is preferable to perform correction that is to make the reference color temperature higher as the color temperature ratio of environment light to fill light is lower. The image processing apparatus 200 in the second embodiment is different from the first embodiment in the point of obtaining the color temperature of environment light and generating a correction coefficient based on the color temperature ratio of the environment light to the fill light.

The white balance gain correcting section 270 in the second embodiment reads an environment light white balance gain WB_e from an environment light white balance gain holding section 220. The white balance gain correcting section 270 then obtains the color temperature of the environment light based on the environment light white balance gain WB_e. Since the color temperature of the fill light is generally a fixed value, the color temperature ratio of the environment light to the fill light is obtained based on the color temperature of the environment light. The white balance gain correcting section 270 makes the correction coefficient Km larger as the relative color temperature of the environment light is lower so as to correct the combined white balance gain WB_m. Note that when the color temperature of the environment light is higher than that of the fill light, the white balance gain correcting section 270 may make the correction coefficient Km smaller as the relative color temperature of the environment light is higher for correction of the white balance gain WB_m.

[Configuration Example of White Balance Gain Correcting Section]

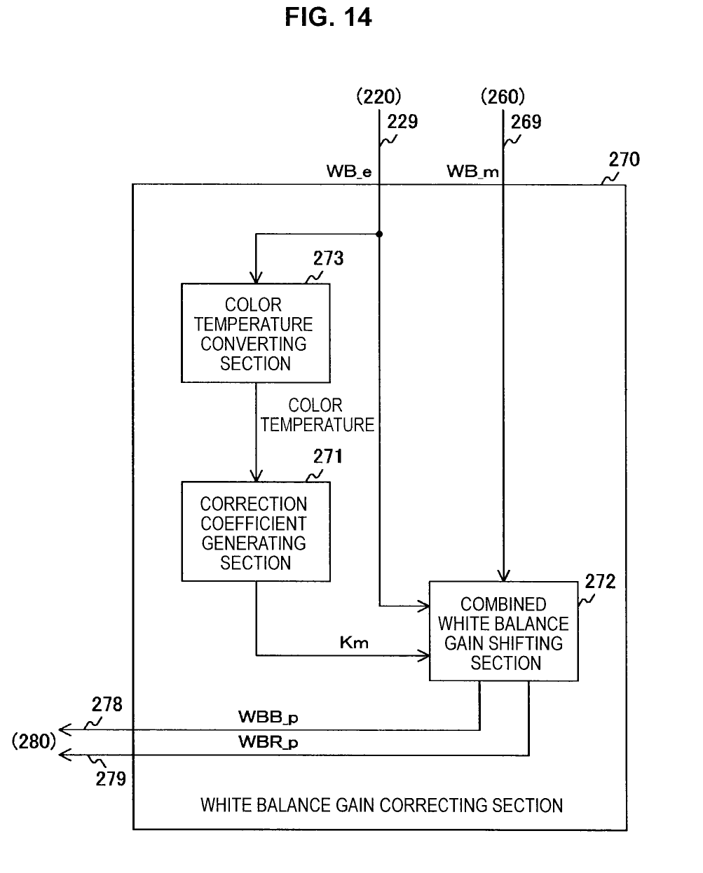

FIG. 14 is a block diagram showing one configuration example of the white balance gain correcting section 270 in the second embodiment. The white balance gain correcting section 270 of the second embodiment is different from that of the first embodiment in the point that a color temperature converting section 273 is further included.

The color temperature converting section 273 is configured to convert the environment light white balance gain WB_e into an environment light color temperature. More specifically, the color temperature converting section 273 obtains, as the color temperature of environment light, a color temperature that the environment light white balance gain WB_e uses as a reference color temperature. For example, a reference color temperature corresponding to a value WB_e on a curve of FIG. 11 serves as the color temperature of environment light. The color temperature converting section 273 supplies the color temperature of environment light to the correction coefficient generating section 271.

The correction coefficient generating section 271 of the second embodiment generates a large correction coefficient Km as the color temperature ratio of the environment light to the fill light becomes lower, and supplies the generated coefficient to the combined white balance gain shifting section 272. The configuration of the combined white balance gain shifting section 272 in the second embodiment is similar to that in the first embodiment.

Although the white balance gain correcting section 270 generates the proper white balance gain WB_p to be applied to the entire image, a proper white balance gain WB_p to be applied to a block may be generated for every block in the image data.

When the proper white balance gain WB_p is generated for every block, the environment light white balance gain generating section 210 calculates an environmental white balance gain WB_e(i, j) for every block by using the following formulas 15 and 16 for example.

WBR_{—}e(i,j)=B_{G}(i,j)/B_{R}(i,j) Formula 15

WBB_{—}e(i,j)=B_{G}(i,j)/B_{B}(i,j) Formula 16

The correction coefficient generating section 271 generates a correction coefficient Km(i, j) for every block based on the environmental white balance gain WB_e(i, j). The combined white balance gain shifting section 272 generates a proper white balance gain WB_p (i, j) for every block based on those correction coefficients Km(i, j).

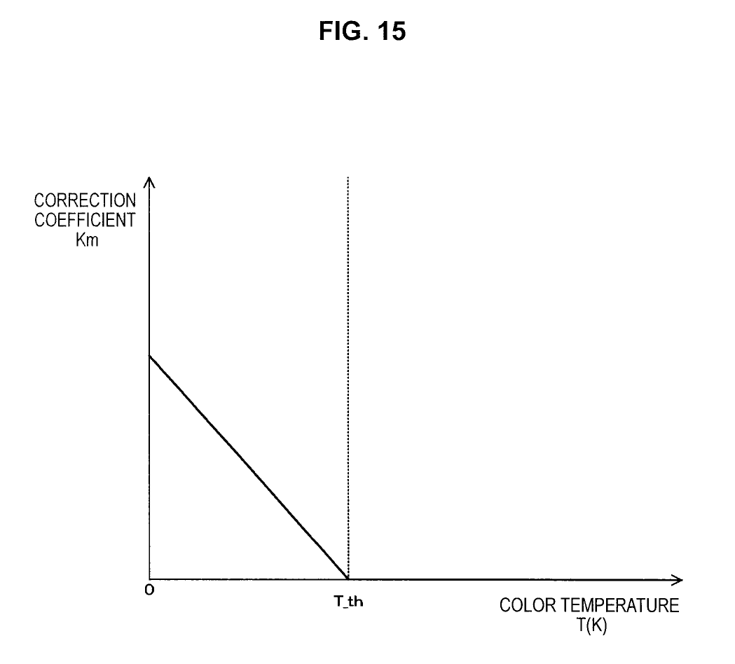

FIG. 15 is a view showing one example of a relation between a correction coefficient Km and an environment light color temperature T in the second embodiment. In FIG. 15, a vertical axis represents the correction coefficient Km while a horizontal axis represents the environment light color temperature T. The unit of the color temperature T is kelvin (K), for example. As illustrated in FIG. 15, as the environment light color temperature T becomes lower, a larger value is set as the correction coefficient Km so as to correct the reference color temperature to be higher.

Thus, according to the second embodiment of the present technology, the image processing apparatus 200 can correct the combined white balance gain WB_m in accordance with the color temperature ratio of environment light to fill light. As a consequence, in accordance with the color temperature ratio of environment light to fill light, the color shades of the environment light are emphasized. Therefore, the image processing apparatus 200 can adjust the color shades of the image data to be natural color shades.

### 3. Third Embodiment

[Configuration Example of Image Processing Apparatus]

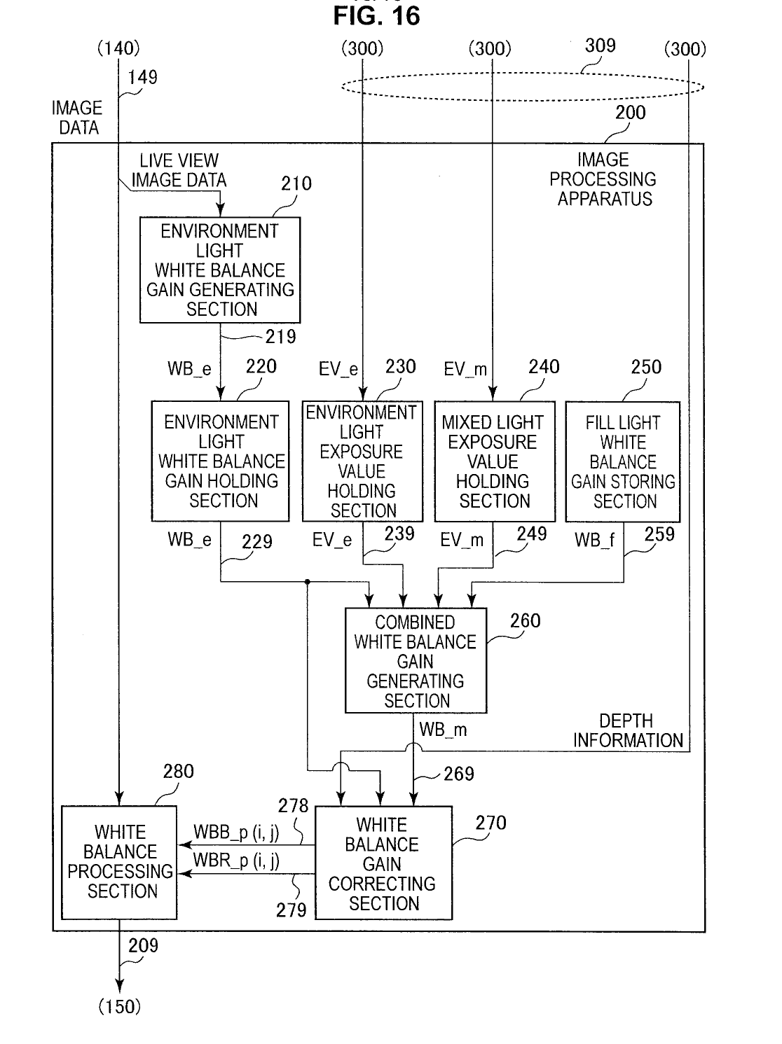

FIG. 16 is a block diagram showing one configuration example of an image processing apparatus 200 in a third embodiment. In the first embodiment, the image processing apparatus 200 calculates the light amount ratio or the color temperature ratio of environment light to fill light based on the exposure value of the environment light. However, the image processing apparatus 200 may also obtain the ratio of environment light to fill light or the ratio in a color temperature based on a value other than the exposure value. More specifically, since the ratio of environment light to fill light becomes smaller as a depth to a subject is smaller, the light amount ratio can be obtained based on the depth. The image processing apparatus 200 of the third embodiment is different from that of the first embodiment in the point that the depth to a subject is obtained and the ratio of environment light to fill light is determined based on the depth.

More specifically, a white balance gain correcting section 270 of the third embodiment further receives depth information from a camera control apparatus 300. The depth information is information indicating the depth in every block in the image data. The flash 170 is generally closer as the depth is smaller, and so the light amount or the color temperature of fill light becomes relatively larger. In other words, with a smaller depth, the relative light amount or the color temperature of environment light becomes smaller. Therefore, the white balance gain correcting section 270 corrects the reference color temperature in accordance with the depth. For example, as the depth is smaller, the white balance gain correcting section 270 makes the correction coefficient Km larger and makes the reference color temperature higher. It is to be noted that the color temperature of environment light may be higher than that of fill light in some cases. In these cases, as the depth becomes smaller, the relative color temperature of environment light becomes larger. Accordingly, the white balance gain correcting section 270 makes the correction coefficient Km smaller as the depth is smaller so as to make the reference color temperature lower.

[Configuration Example of White Balance Gain Correcting Section]

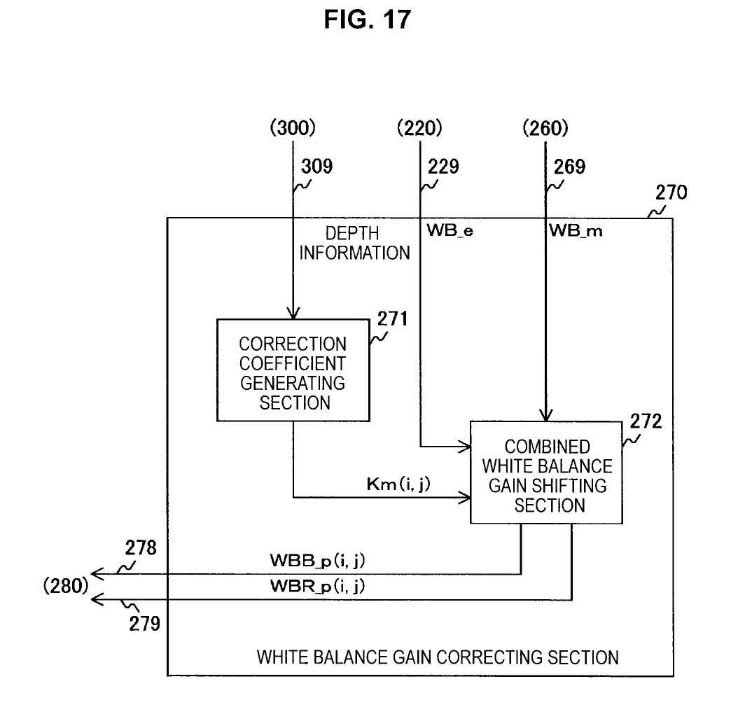

FIG. 17 is a block diagram showing one configuration example of the white balance gain correcting section 270 in the third embodiment. The correction coefficient generating section 271 of the third embodiment generates a larger correction coefficient Km(i, j) for a block (i, j) as the depth of the block indicated by the depth information is smaller. The combined white balance gain shifting section 272 of the third embodiment uses the correction coefficient K (i, j) to obtain a proper white balance gain WB_p (i, j) of the block (i, j).

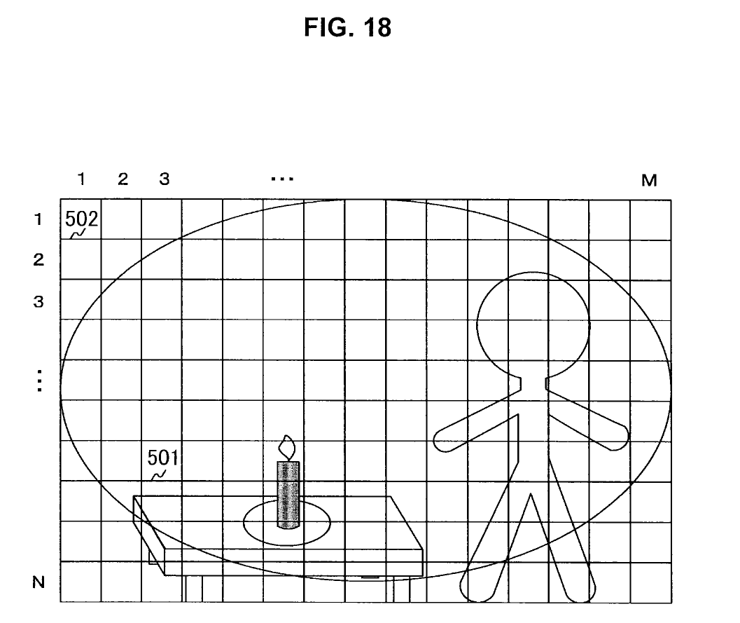

FIG. 18 is a view showing one example of a range covered by fill light in the third embodiment. An ellipse of FIG. 18 is a range covered by fill light in image data. In a block 501 within this range, there is shown a desk which is relatively on the near side. Meanwhile, in a block 502 that is out of the range covered by the fill light, there is shown a wall which is relatively on the back side.

In this case, a subject in the block 501 having a small depth is inside the range covered by the fill light, and therefore the relative light amount or the color temperature of environment light becomes small. In contrast, a subject in the block 502 having a large depth is out of the range covered by the fill light, and therefore the relative light amount or the color temperature of environment light becomes large. Accordingly, the correction coefficient Km of the block 501 having a small depth is set larger than that of the block 502 having a large depth.

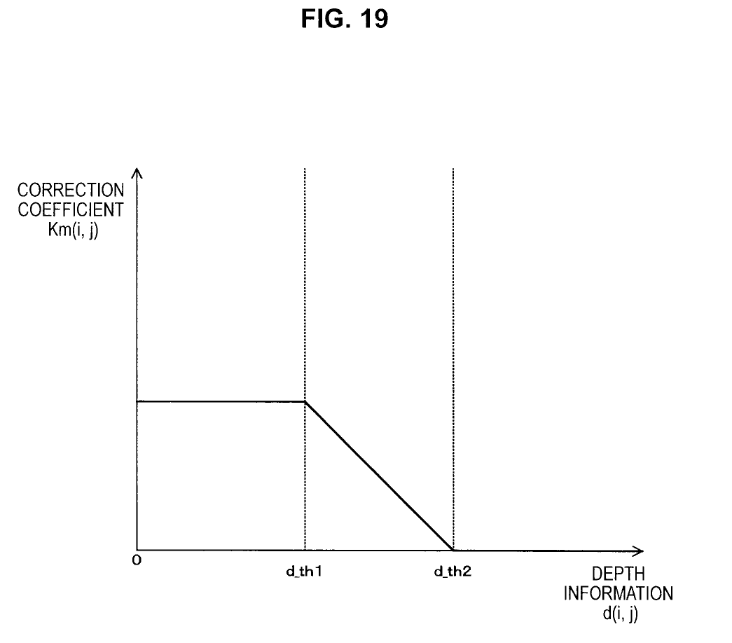

FIG. 19 is a view showing one example of a relation between a correction coefficient and depth information in a modified example of the third embodiment. In FIG. 19, a vertical axis represents the correction coefficient Km(i, j) of a block (i, j). A horizontal axis represents the depth information d(i, j) of the block (i, j). When the depth d(i, j) is equal to or more than a threshold d_th 2, the relative light amount or the color temperature of environment light is sufficiently large and therefore the need for correction is low. Accordingly, a fixed value (e.g., “0”) is set as the correction coefficient Km(i, j).

When the depth d(i, j) is smaller than the threshold d_th 2 and is equal to or more than a threshold d_th 1, a larger correction coefficient is set with a smaller depth. When the depth d(i, j) is smaller than the threshold d_th1, the correction coefficient, if set to be larger, may cause excessive correction, and therefore, a fixed value is set as the correction coefficient Km(i, j). As the fixed value, the correction coefficient Km(i, j) in the case of d_th1 may be set for example.

Thus, according to the third embodiment of the present technology, the image processing apparatus 200 can determine that the ratio of environment light to fill light is smaller as the depth is smaller and can correct the combined white balance gain WB_m in accordance with the ratio. As a consequence, in accordance with the ratio of environment light to fill light, the color shades of the environment light are emphasized. Therefore, the image processing apparatus 200 can adjust the color shades of the image data to be natural color shades.

Note that the above described embodiments show examples of embodying the present disclosure, and there is a correspondence between the features in the embodiments and the respective features of the present disclosure. Similarly, there is a correspondence between the features of the present disclosure and the respective features in the embodiments of the present disclosure with the same reference numerals. However, the present disclosure is not limited to the embodiments, and can embody various modifications which do not deviate from the scope of the present disclosure.

Further, the procedures described in each of the aforementioned embodiments may be understood as a method including a series of these procedures, and may be understood as a program for causing a computer to execute the series of these procedures or a recording medium storing the program therein. As the recording medium, for example, a hard disk, a CD (a Compact Disc), an MD (a MiniDisc), a DVD (a Digital Versatile Disk), a memory card, or Blu-ray Disc (registered trademark) can be used.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing apparatus including:

an environment light white balance gain generating section configured to generate an environment light white balance gain from an image taken under environment light;

a combined white balance gain generating section configured to combine a fill light white balance gain corresponding to a color temperature of fill light with the environment light white balance gain to generate a combined white balance gain; and

a white balance gain correcting section configured to correct the combined white balance gain in accordance with a ratio of the environment light to the fill light,

wherein the corrected combined white balance gain is applied to an image taken under mixed light including the fill light and the environment light.

(2) The image processing apparatus according to (1),

wherein the white balance gain correcting section performs, on the combined white balance gain, correction to change a reference color temperature in accordance with a light amount ratio of the environment light to the fill light.

(3) The image processing apparatus according to (1) or (2),

wherein the white balance gain correcting section performs, on the combined white balance gain, correction to generate a color temperature of the environment light from the environment light white balance gain and to change a reference color temperature in accordance with a ratio of the obtained color temperature ratio of the environment light to the color temperature of the fill light.

(4) The image processing apparatus according to any one of (1) to (3),

wherein the white balance gain correcting section determines that the ratio of the environment light to the fill light is lower as a depth to an object in the image taken under the environment light is smaller.

(5) The image processing apparatus according to any one of (1) to (4),

wherein the image has a plurality of regions, and

the white balance gain correcting section obtains the ratio of the environment light to the fill light in each of the plurality of regions and corrects the combined white balance in each of the plurality of regions.

(6) The image processing apparatus according to any one of (1) to (5), further including:

a white balance processing section configured to execute white balance processing of the image taken under the mixed light by using the corrected white balance gain.

(7) A method for image processing including:

an environment light white balance gain generation procedure of an environment light white balance gain generating section generating an environment light white balance gain from an image taken under environment light;

a combined white balance gain generation procedure of a combined white balance gain generating section combining a fill light white balance gain corresponding to a color temperature of fill light with the environment light white balance gain to generate a combined white balance gain;

a white balance gain correction procedure of a white balance gain correcting section correcting the combined white balance gain in accordance with a ratio of the environment light to the fill light; and

a procedure of applying the corrected combined white balance gain to an image taken under mixed light including the fill light and the environment light.

(8) A program for causing a computer execute:

an environment light white balance gain generation procedure of an environment light white balance gain generating section generating an environment light white balance gain from an image taken under environment light;

a combined white balance gain generation procedure of a combined white balance gain generating section combining a fill light white balance gain corresponding to a color temperature of fill light with the environment light white balance gain to generate a combined white balance gain;

a white balance gain correction procedure of a white balance gain correcting section correcting the combined white balance gain in accordance with a ratio of the environment light to the fill light; and

a procedure of applying the corrected combined white balance gain to an image taken under mixed light including the fill light and the environment light.

The present disclosure contains subject matter related to that disclosed in Japanese Priority Patent Application JP 2012-151343 filed in the Japan Patent Office on Jul. 5, 2012, the entire content of which is hereby incorporated by reference.

What is claimed is:

1. An image processing apparatus comprising:
an environment light white balance gain generating section configured to generate an environment light white balance gain from an image taken under environment light;
a combined white balance gain generating section configured to combine a fill light white balance gain corresponding to a color temperature of fill light with the environment light white balance gain to generate a combined white balance gain; and
a white balance gain correcting section configured to correct the combined white balance gain in accordance with a ratio of the environment light to the fill light,
wherein the corrected combined white balance gain is applied to an image taken under mixed light including the fill light and the environment light.

2. The image processing apparatus according to claim 1,
wherein the white balance gain correcting section performs, on the combined white balance gain, correction to change a reference color temperature in accordance with a light amount ratio of the environment light to the fill light.

3. The image processing apparatus according to claim 1,
wherein the white balance gain correcting section performs, on the combined white balance gain, correction to generate a color temperature of the environment light from the environment light white balance gain and to change a reference color temperature in accordance with a ratio of the obtained color temperature ratio of the environment light to the color temperature of the fill light.

4. The image processing apparatus according to claim 1,
wherein the white balance gain correcting section determines that the ratio of the environment light to the fill light is lower as a depth to an object in the image taken under the environment light is smaller.

5. The image processing apparatus according to claim 1,
wherein the image has a plurality of regions, and
the white balance gain correcting section obtains the ratio of the environment light to the fill light in each of the plurality of regions and corrects the combined white balance in each of the plurality of regions.

6. The image processing apparatus according to claim 1, further comprising:
a white balance processing section configured to execute white balance processing of the image taken under the mixed light by using the corrected white balance gain.

7. A method for image processing comprising:
an environment light white balance gain generation procedure of an environment light white balance gain generating section generating an environment light white balance gain from an image taken under environment light;
a combined white balance gain generation procedure of a combined white balance gain generating section combining a fill light white balance gain corresponding to a color temperature of fill light with the environment light white balance gain to generate a combined white balance gain;
a white balance gain correction procedure of a white balance gain correcting section correcting the combined white balance gain in accordance with a ratio of the environment light to the fill light; and
a procedure of applying the corrected combined white balance gain to an image taken under mixed light including the fill light and the environment light.

8. A program for causing a computer execute:
an environment light white balance gain generation procedure of an environment light white balance gain generating section generating an environment light white balance gain from an image taken under environment light;
a combined white balance gain generation procedure of a combined white balance gain generating section combining a fill light white balance gain corresponding to a color temperature of fill light with the environment light white balance gain to generate a combined white balance gain;
a white balance gain correction procedure of a white balance gain correcting section correcting the combined white balance gain in accordance with a ratio of the environment light to the fill light; and
a procedure of applying the corrected combined white balance gain to an image taken under mixed light including the fill light and the environment light.
